(19) United States
(12) Patent Application Publication
(10) Pub. No.: US 2019/0056009 A1
(43) Pub. Date: Feb. 21, 2019

(54) CYLINDER DEVICE AND METHOD OF PRODUCING THE SAME

(71) Applicant: HITACHI AUTOMOTIVE SYSTEMS, LTD., Ibaraki (JP)

(72) Inventors: Yasuhiro AOKI, Yokohama-shi, Kanagawa (JP); Osamu YUNO, Yokohama-shi, Kanagawa (JP); Umi TANABE, Kawasaki-shi, Kanagawa (JP)

(21) Appl. No.: 16/079,803

(22) PCT Filed: Feb. 23, 2017
(86) PCT No.: PCT/JP2017/006850

§ 371 Date: Aug. 24, 2018

(30) Foreign Application Priority Data
Feb. 24, 2016 (JP) 2016-033331

(51) Int. Cl. F16F 9/32; F16F 9/46; F16F 9/53

(52) U.S. Cl. CPC F16F 9/3257; F16F 9/463; F16F 2224/045; F16F 2224/043; F16F 9/537

(57) ABSTRACT

A cylinder device that enables both prevention of leakage from a flow channel and improvement of assemblability. A shock absorber is filled with an electrorheological fluid as a hydraulic fluid. The shock absorber generates a potential difference within an electrode path and controls viscosity of the electrorheological fluid passing through the electrode path, thus controlling a generated damping force. A plurality of partition walls are disposed between an inner cylinder and an electrode tube. A plurality of spiral flow channels are formed between the inner cylinder and the electrode tube. The partition walls are attached to the outer peripheral surface of the inner cylinder. The partition walls have a sectional shape in which an electrode tube side is smaller in wall thickness than an inner cylinder side. The partition walls include a pointed tip on the non-attached side, which is oriented to a high pressure side of the flow channels.

### TECHNICAL FIELD

The invention relates to cylinder devices suitably used to absorb vibration of vehicles, such as automobiles and rail vehicles, and a method of producing the same.

### BACKGROUND ART

A vehicles, such as an automobile, is generally equipped with a cylinder device, as typified by a hydraulic shock absorber, between a vehicle body (sprung mass) side and a wheel (unsprung mass) side. For example, a Patent Literature 1 discloses that a damper (shock absorber) using an electrorheological fluid as a hydraulic fluid is provided with spiral members as circular cross-sectional sealing means between an inner cylinder and an electrode tube (intermediate cylinder), and that a space between the spiral members functions as a flow channel.

### CITATION LIST

### Patent Literature

PTL 1: International Publication WO 2014/135183

### SUMMARY OF INVENTION

### Technical Problem

A conceivable way to prevent the hydraulic fluid from leaking from between the electrode tube and each of the spiral members (hydraulic fluid from escaping from the flow channel) is, for example, to provide interference in fitting of the electrode tube and the spiral members. On the other hand, a larger interference results in a higher insertion load at the assembly of the electrode tube and the inner cylinder, and might degrade assemblability (ease of assembly).

It is an object of the invention to provide a cylinder device which enables both prevention of leakage from a flow channel and improvement of assemblability at the same time, and a method of producing the same.

### Solution to Problem

To solve the problem mentioned above, a cylinder device of the invention comprises an inner cylinder configured to sealingly contain a functional fluid that changes in fluid properties due to an electric or magnetic field, the inner cylinder through which a rod extends; an intermediate cylinder disposed at an outer side of the inner cylinder and functioning as an electrode tube or a magnetic pole tube; and flow-channel forming means disposed between the inner cylinder and the intermediate cylinder and forming one or more flow channels through which the functional fluid flows from one axial end side toward the other axial end side in response to a back-and-forth movement of the rod. The flow channel is a spiral or meandering flow channel including a portion extending in a circumferential direction. The flow-channel forming means is attached to either the inner cylinder or the intermediate cylinder. The flow-channel forming means has a sectional shape in which a non-attached side is smaller in wall thickness than an attached side, and in which a pointed tip of the non-attached side is oriented to a high pressure side of the flow channel.

A method of producing a cylinder device according to the invention comprises an inner cylinder configured to sealingly contain a functional fluid that changes in fluid properties due to an electric or magnetic field, the inner cylinder through which a rod extends; an intermediate cylinder disposed at an outer side of the inner cylinder and functioning as an electrode tube or a magnetic pole tube; and flow-channel forming means disposed between the inner cylinder and the intermediate cylinder and forming one or more flow channels through which the functional fluid flows from one axial end side toward the other axial end side in response to a back-and-forth movement of the rod. The flow channel is a spiral or meandering flow channel including a portion extending in a circumferential direction. The flow-channel forming means is attached to an outer peripheral side of the inner cylinder (or an inner peripheral side of the intermediate cylinder). The flow-channel forming means has a sectional shape in which a non-attached side is thinner in wall thickness than an attached side. The method comprises an insertion step of inserting the inner cylinder from a low (or high) pressure side of the inner cylinder into a high (or low) pressure-side opening of the intermediate cylinder.

### Advantageous Effects of Invention

The cylinder device and the method of producing the same according to the invention enable both the prevention of leakage from the flow channel and the improvement of assemblability at the same time.

### BRIEF DESCRIPTION OF DRAWINGS

FIG. 1 is a longitudinal sectional view showing a shock absorber as a cylinder device according to a first embodiment.

FIG. 2 is an elevation view showing an inner cylinder and flow-channel forming means (partition wall).

FIG. 3 is a longitudinal sectional view of the inner cylinder, the flow-channel forming means, and an intermediate cylinder (electrode tube), emphasizing their size, deformation of the flow-channel forming means, and the like.

FIG. 4 is a longitudinal sectional view emphasizing an assembling process (inserting process) of the inner cylinder and the intermediate cylinder.

FIG. 5 is a longitudinal sectional view emphasizing an inner cylinder, flow-channel forming means, and an intermediate cylinder according to a second embodiment.

FIG. 6 is a longitudinal sectional view emphasizing an assembling process (inserting process) of the inner cylinder and (in) the intermediate cylinder.

FIG. 7 is a longitudinal sectional view emphasizing an inner cylinder, flow-channel forming means, and an intermediate cylinder according to a third embodiment.

FIG. 8 is a longitudinal sectional view emphasizing an assembling process (inserting process) of the inner cylinder and (in) the intermediate cylinder.

FIG. 9 is an elevation view showing an inner cylinder and flow-channel forming means according to a fourth embodiment.

FIG. 10 is a perspective view showing the inner cylinder and the flow-channel forming means.

FIG. 11 is a cross-sectional view emphasizing the inner cylinder, the flow-channel forming means, and the intermediate cylinder.

FIG. 12 is a cross-sectional view emphasizing the inner cylinder and the flow-channel forming means.

### DESCRIPTION OF EMBODIMENTS

A cylinder device according to embodiments will be discussed below with reference to the attached drawings, giving an example in which the cylinder device is applied to a shock absorber of a vehicle, such as a four-wheel automobile.

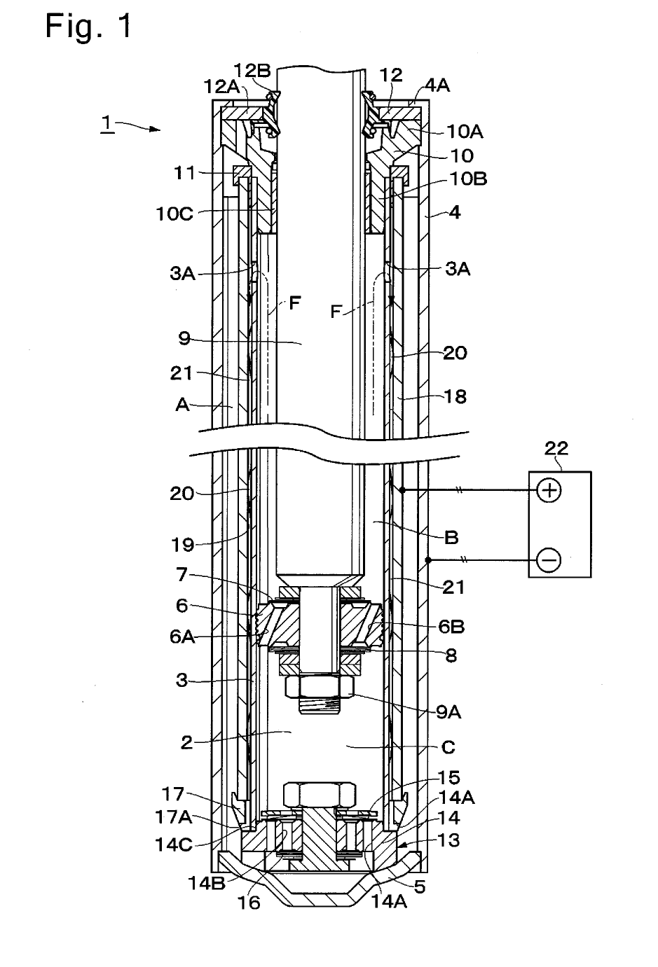

FIGS. 1 to 4 show a first embodiment. In FIG. 1, a shock absorber 1 as the cylinder device is configured as an adjustable hydraulic shock absorber (semi-active damper) using a functional fluid (i.e., electrorheological fluid) as a hydraulic fluid 2, such as hydraulic oil, which is sealingly contained in the shock absorber 1. The shock absorber 1 constitutes a suspension device for a vehicle in conjunction with a suspension spring, not shown, which comprises, for example, a coil spring. Hereinafter, one axial end side of the shock absorber 1 will be referred to as a “lower end” side, and the other axial end side as an “upper end” side although the one axial end side of the shock absorber 1 may be referred to as an “upper end” side, and the other axial end side as a “lower end” side.

The shock absorber 1 includes an inner cylinder 3, an outer cylinder 4, a piston 6, a piston rod 9, a bottom valve 13, an electrode tube 18, and the like. The inner cylinder 3 is formed into a tubular cylindrical body extending in an axial direction. The inner cylinder 3 sealingly contains the hydraulic fluid 2 that is the functional fluid. The piston rod 9 extends through the inner cylinder 3. The outer cylinder 4 and the electrode tube 18 are coaxially disposed at an outer side of the inner cylinder 3.

The inner cylinder 3 has a lower end side fitted to a valve body 14 of the bottom valve 13 and an upper end side fitted to a rod guide 10. The inner cylinder 3 is formed with a plurality of (four, for example) oil holes 3A which are normally in communication with an electrode path 19. The oil holes 3A are formed into radial transverse holes and arranged at intervals in a circumferential direction. A rod-side oil chamber B located inside the inner cylinder 3 is in communication with the electrode path 19 through the oil holes 3A.

The outer cylinder 4 is an outer shell of the shock absorber 1 and formed into a cylindrical body. The outer cylinder 4 is disposed at an outer periphery of the electrode tube 18 and forms a reservoir chamber A between the outer cylinder 4 and the electrode tube 18. The reservoir chamber A is in communication with the electrode path 19. In this case, the outer cylinder 4 has a lower end side formed into a closed end which is closed with a bottom cap 5 by using welding means or other like means. The bottom cap 5 constitutes a base member in conjunction with the valve body 14 of the bottom valve 13.

The outer cylinder 4 has an upper end side that is an open end. In an open end side of the outer cylinder 4, for example, a caulking portion 4A is so formed as to bend in a radially inward direction. The caulking portion 4A holds an outer peripheral side of an annular plate element 12A of a seal member 12 in a retaining manner.

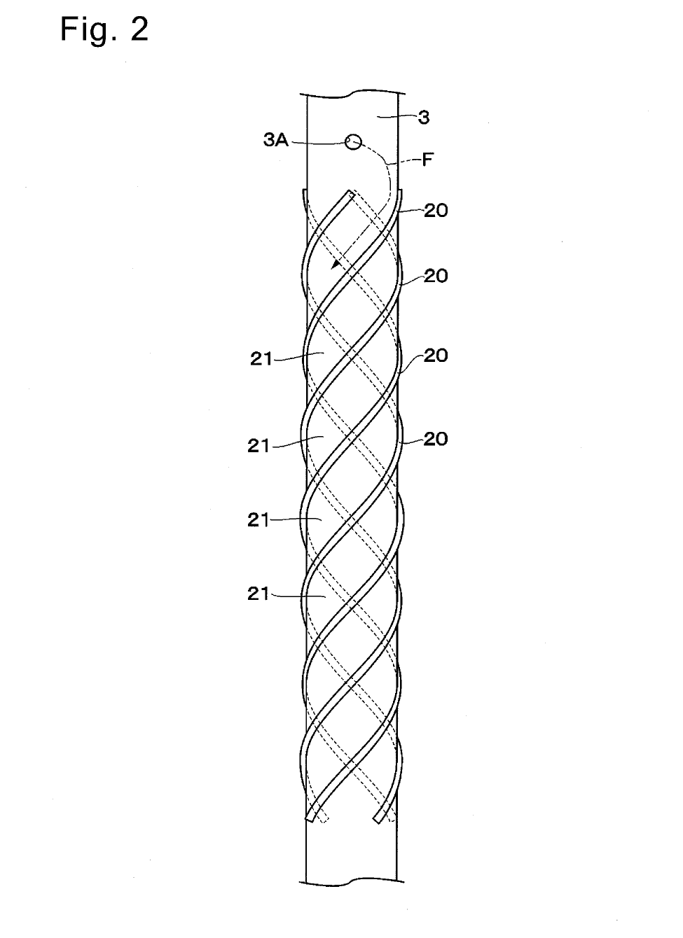

The inner cylinder 3 and the outer cylinder 4 form a cylinder. The cylinder sealingly contains the hydraulic fluid 2. In the embodiments, the electrorheological fluid (ERF: Electro Rheological Fluid), which is a form of functional fluid, is used as a fluid filled (sealingly contained) in the cylinder, that is, used as the hydraulic fluid 2 functioning as the hydraulic oil. In FIGS. 1 and 2, the hydraulic fluid 2 sealingly contained is colorless and transparent.

The electrorheological fluid is a fluid (functional fluid) that changes in properties due to an electric field (voltage). More specifically, the electrorheological fluid changes in viscosity according to applied voltage and thus changes in flow resistance (damping force). The electrorheological fluid contains, for example, base oil (baseoil) consisting of silicon oil or the like, and particles (fine particles) mixed (dispersed) into the base oil to make viscosity variable along with changes of the electric field.

As described later, the shock absorber 1 is configured to generate a potential difference within the electrode path 19 between the inner cylinder 3 and the electrode tube 18 and control the viscosity of the electrorheological fluid passing through the electrode path 19, to thereby control (adjust) a generated damping force. The embodiments are discussed, taking the electrorheological fluid (ER fluid) as an example of the functional fluid. For another example, the functional fluid may be a magnetorheological fluid (MR fluid) that changes in fluid properties due to the magnetic field.

Formed between the inner cylinder 3 and the outer cylinder 4, or more specifically, between the electrode tube 18 and the outer cylinder 4 is the annular reservoir chamber A functioning as a reservoir. The reservoir chamber A sealingly contains a gas functioning as the hydraulic fluid together with the hydraulic fluid 2. The gas may be air under atmospheric pressure or a gas such as a compressed nitrogen gas. The gas contained in the reservoir chamber A is compressed to compensate an entered volume of the piston rod 9 during contraction (compression stroke) of the piston rod 9.

The piston 6 is slidably provided in the inner cylinder 3. The piston 6 divides an internal space of the inner cylinder 3 into the rod-side oil chamber B that is a first chamber and a bottom-side oil chamber C that is a second chamber. In the piston 6, a plurality of oil paths 6A and a plurality of oil paths 6B are formed at intervals in the circumferential direction. The oil paths 6A and 6B allow the rod-side oil chamber B and the bottom-side oil chamber C to be in communication with each other.

The shock absorber 1 according to the embodiments has a uniflow structure. Accordingly, the hydraulic fluid 2 contained in the inner cylinder 3 normally flows in one direction (i.e. a direction of arrows F shown by two-dot chain lines in FIG. 1) from the rod-side oil chamber B (i.e. oil holes 3A of the inner cylinder 3) toward the electrode path 19 during both compression and expansion strokes of the piston rod 9.

To materialize the uniflow structure, for example, a compression check valve 7 is disposed at an upper end surface of the piston 6. The compression check valve 7 is opened when the piston 6 is downwardly displaced in a sliding manner within the inner cylinder 3 during the contraction stroke (compression stroke) of the piston rod 9, and is otherwise closed. The compression check valve 7 allows oil (hydraulic fluid 2) contained in the bottom-side oil chamber C to flow through the oil paths 6A toward the rod-side oil chamber B and blocks the oil from flowing in the other direction. The compression check valve 7 thus permits only the flow of the hydraulic fluid 2 from the bottom-side oil chamber C to the rod-side oil chamber B.

A lower end surface of the piston 6 is provided with, for example, an extension disc valve 8. When the piston 6 is upwardly displaced in the sliding manner within the inner cylinder 3 during an extension stroke (expansion stroke) of the piston rod 9, the extension disc valve 8 is opened at a time point when pressure inside the rod-side oil chamber B exceeds a relief set pressure, to thereby release the pressure at this time point toward the bottom-side oil chamber C through the oil paths 6B.

The piston rod 9 as the rod extends through the inner cylinder 3 in an axial direction (the same direction as central axes of the inner and outer cylinders 3 and 4 and thus the same direction as a central axis of the shock absorber 1, and a vertical direction on FIGS. 1 and 2). To be more specific, the piston rod 9 has a lower end jointed (fixed) to the piston 6 within the inner cylinder 3 and an upper end extending through the rod-side oil chamber B to the outside of the inner and outer cylinders 3 and 4. In this case, the piston 6 is fixed (attached) to a lower end side of the piston rod 9 with a nut 9A or the like. The piston rod 9 has an upper end side extending through the rod guide 10 to protrude outside. The piston rod 9 may be a so-called double rod in which the lower end of the piston rod 9 further extends to protrude outward from a bottom portion (bottom cap 5, for example) side.

A stepped tube-like rod guide 10 is fitted in and closes the upper end sides of the inner and outer cylinders 3 and 4. The rod guide 10 supports the piston rod 9. The rod guide 10 is formed into a cylindrical body having a predetermined shape, for example, by applying molding process, cutting work or the like to metal material, hard resin material or another like material. The rod guide 10 positions an upper portion of the inner cylinder 3 and an upper portion of the electrode tube 18 at a center of the outer cylinder 4. In addition, the rod guide 10 directs (guides) the piston rod 9 on an inner peripheral side of the rod guide 10 in an axially slidable manner.

The rod guide 10 is formed into a stepped tube including an annular large-diameter portion 10A located on an upper side and inserted in an inner peripheral side of the outer cylinder 4, and a short cylinder-like small-diameter portion 10B located on a lower end side of the large-diameter portion 10A and inserted in an inner peripheral side of the inner cylinder 3. In an inner peripheral side of the small-diameter portion 10B of the rod guide 10, there is disposed a guide portion 10C which guides the piston rod 9 in an axially slidable manner. The guide portion 10C is formed, for example, by coating an inner peripheral surface of a metal cylinder with tetrafluoroethylene.

An annular retaining member 11 is fitted between the large-diameter portion 10A and the small-diameter portion 10B on an outer peripheral side of the rod guide 10. The retaining member 11 holds an upper end side of the electrode tube 18 in a position determined in the axial direction. The retaining member 11 is made of, for example, an electrical insulating material (isolator) and keeps the inner cylinder 3 and the rod guide 10 electrically isolated from the electrode tube 18.

The annular seal member 12 is disposed between the large-diameter portion 10A of the rod guide 10 and the calking portion 4A of the outer cylinder 4. The seal member 12 includes the annular plate element 12A made of metal, which is provided in the center with a hole through which the piston rod 9 extends, and an elastic body 12B made of an elastic material, such as rubber, which is attached to the annular plate element 12A by baking or another like method. The seal member 12 plugs (seals) a gap between the seal member 12 and the piston rod 9 in a liquid- and air-tight manner by an inner periphery of the elastic body 12B coming into sliding contact with the outer peripheral side of the piston rod 9.

The bottom valve 13 is disposed at the lower end side of the inner cylinder 3 to be located between the inner cylinder 3 and the bottom cap 5. The bottom valve 13 connects/disconnects the bottom-side oil chamber C to/from the reservoir chamber A. To that end, the bottom valve 13 includes the valve body 14, an expansion check valve 15, and a disc valve 16. The valve body 14 is located between the bottom cap 5 and the inner cylinder 3 to separate the reservoir chamber A and the bottom-side oil chamber C from each other.

In the valve body 14, oil paths 14A and 14B are formed at intervals in the circumferential direction. The oil paths 14A and 14B allow the reservoir chamber A and the bottom-side oil chamber C to be in communication with each other. The valve body 14 is formed with a stepped portion 14C on an outer peripheral side thereof. An inner peripheral side of the lower end of the inner cylinder 3 is fitted and fixed to the stepped portion 14C. An annular retaining member 17 is fitted to an outer peripheral side of the inner cylinder 3 to be mounted on the stepped portion 14C.

The expansion check valve 15 is disposed, for example, on an upper surface side of the valve body 14. The expansion check valve 15 is opened when the piston 6 is upwardly displaced in the sliding manner during the extension stroke of the piston rod 9, and is otherwise closed. The expansion check valve 15 allows oil (hydraulic fluid 2) contained in the reservoir chamber A to flow through the oil paths 14A toward the bottom-side oil chamber C and blocks the oil from flowing in its opposite direction. In short, the expansion check valve 15 permits only the flow of the hydraulic fluid 2 from the reservoir chamber A side to the bottom-side oil chamber C side.

The disc valve 16 located on the contraction side is disposed, for example, on a lower surface side of the valve body 14. When the piston 6 is downwardly displaced in the sliding manner during the contraction stroke of the piston rod 9, the disc valve 16 on the contraction side is opened at a time point when pressure inside the bottom-side oil chamber C exceeds a relief set pressure, to thereby release the pressure at this time point to the reservoir chamber A side through the oil paths 14B.

The retaining member 17 holds a lower end side of the electrode tube 18 in a position determined in the axial direction. The retaining member 17 is made of, for example, an electrical insulating material (isolator) and keeps the inner cylinder 3 and the valve body 14 electrically isolated from the electrode tube 18. The retaining member 17 is formed with a plurality of oil paths 17A connecting the electric path 19 to the reservoir chamber A.

The electrode tube 18 comprising a pressure tube extending in the axial direction is disposed at an outer side of the inner cylinder 3, or between the inner cylinder 3 and the outer cylinder 4. The electrode tube 18 is an intermediate cylinder located between the inner cylinder 3 and the outer cylinder 4. The electrode tube 18 is made of a conductive material and constitutes a cylindrical electrode. The electrode tube 18 forms the electrode path 19 between the electrode tube 18 and the inner cylinder 3. The electrode path 19 is in communication with the rod-side oil chamber B.

More specifically, the electrode tube 18 is mounted on the outer peripheral side of the inner cylinder 3 by the retaining members 11 and 17. The retaining members 11 and 17 are disposed axially (vertically) away from each other. The electrode tube 18 encloses the outer peripheral side of the inner cylinder 3 over the whole circumference and thus forms an annular path between an inner portion of the electrode tube 18, or an inner peripheral side of the electrode tube 18 and the outer peripheral side of the inner cylinder 3, that is, the electrode path 19 functioning as an intermediate path through which the hydraulic fluid 2 flows. In the electrode path 19, a plurality of flow channels 21 are formed by a plurality of partition walls 20.

The electrode path 19 is normally in communication with the rod-side oil chamber B through the oil holes 3A formed in the inner cylinder 3 as radial transverse holes. As FIG. 1 shows a flowing direction of the hydraulic fluid 2 by the arrows F, the shock absorber 1 is so configured that the hydraulic fluid 2 enters the electrode path 19 from the rod-side oil chamber B through the oil holes 3A in both the compression and expansion strokes of the piston 6. When the piston rod 9 moves back and forth within the inner cylinder 3 (that is, during a time period when the compression and expansion strokes are repeated), the hydraulic fluid 2 which has entered the electrode path 19 flows from an axially upper end side to an axially lower end side of the electrode path 19 in response to the back-and-forth movement of the piston rod 9. At this time, the hydraulic fluid 2 in the electrode path 19 flows through the flow channels 21 between the two respective adjacent partition walls 20 while being directed by the partition walls 20. The hydraulic fluid 2 which has entered the electrode path 19 flows out from the lower end side of the electrode tube 18 through the oil paths 17A of the retaining member 17 to enter the reservoir chamber A.

The electrode path 19 imparts resistance to a fluid flowing through the outer cylinder 4 and the inner cylinder 3 in response to the sliding movement of the piston 6, that is, the electrorheological fluid as the hydraulic fluid 2. The electrode tube 18 is thus connected to a positive electrode of a battery 22 that is a power source, for example, via a high voltage driver, not shown, which generates high voltage. The battery 22 (and the high voltage driver) functions as a voltage supply portion (electric field supply portion), and the electrode tube 18 functions as an electrode (cathode/anode) which applies an electric field (voltage) to the hydraulic fluid 2 which is the fluid in the electrode path 19, or the electrorheological fluid as the functional fluid. Both end sides of the electrode tube 18 are electrically isolated by the electrically insulating retaining members 11 and 17. The inner cylinder 3 is connected to a negative electrode (ground) via the rod guide 10, the bottom valve 13, the bottom cap 5, the outer cylinder 4, the high voltage driver, and the like.

The high voltage driver raises DC voltage outputted from the battery 22 and then supplies (outputs) the DC voltage to the electrode tube 18 in accordance with a command (high voltage command) outputted from a controller, not shown, for variably adjusting the damping force of the shock absorber 1. A potential difference according to the voltage applied to the electrode tube 18 is thus generated between the electrode tube 18 and the inner cylinder 3, or within the electrode path 19, changing the viscosity of the hydraulic fluid 2 that is the electrorheological fluid. This enables the shock absorber 1 to continuously adjust characteristics of a generated damping force (damping force characteristics) from a stiff (hard) characteristic (hard characteristic) to a loose (soft) characteristic (soft characteristic) on the basis of the voltage applied to the electrode tube 18. The shock absorber 1 may be capable of adjusting the damping force characteristics in two or more stages, instead of the continuous manner.

A Patent Literature 1 discloses a configuration in which spiral members each having a circular sectional shape are disposed between an inner cylinder and an electrode tube, and a space between the spiral members functions as a flow channel. In this configuration, a conceivable way to prevent a hydraulic fluid from leaking from between the electrode tube and each of the spiral members (hydraulic fluid from escaping from the flow channel) is, for example, to provide interference in the fitting of the electrode tube and the spiral members. On the other hand, if the interference is made larger to prevent the leakage from the flow channel, this increases insertion load at the time of assembly of the inner cylinder and the electrode tube, and might degrade assemblability. There also is a possibility that a shearing force applied to between each of the spiral members and the inner cylinder is increased during assembly to make the spiral members fall off the inner cylinder.

Unlike the Patent Literature 1, the first embodiment provides the partition walls 20 corresponding to the spiral members. The partition walls 20 are configured as below. The partition walls 20 as the flow-channel forming means (flow-channel forming members) of the first embodiment will be discussed below with reference not only to FIG. 1, but also to FIGS. 2 to 4.

The partition walls 20 as the flow-channel forming means comprise a plurality of (four) partition walls 20 disposed between the inner cylinder 3 and the electrode tube 18. Each of the partition walls 20 obliquely extends around a circumference between the inner cylinder 3 and the electrode tube 18. The partition walls 20 form the plurality of (four) flow channels 21 between the inner cylinder 3 and the electrode tube 18, or within the electrode path 19. In other words, the partition walls 20 divide the flow of the hydraulic fluid 2 into the plurality of flow channels 21 (direct the flow of the hydraulic fluid 2) between the inner peripheral side of the electrode tube 18 and the outer peripheral side of the inner cylinder 3.

Each of the flow channels 21 is so configured that the hydraulic fluid 2 flows from an axially upper end side toward an axially lower end side in response to the back-and-forth movement of the piston rod 9. As shown in FIG. 2, each of the partition walls 20 is formed into a spiral shape including a portion extending in the circumferential direction. Each of the flow channels 21, which is formed between the two respective adjacent partition walls 20, is therefore also a spiral flow channel including a portion extending in the circumferential direction. In other words, the flow channels 21 are flow channels through which the hydraulic fluid 2 flows clockwise as viewed from an axially upper side (oil hole 3A side) toward an axially lower side of the inner cylinder 3. This makes it possible to form longer flow channels extending from the oil holes 3A to the oil paths 17A of the retaining member, as compared to flow channels axially extending in a linear fashion.

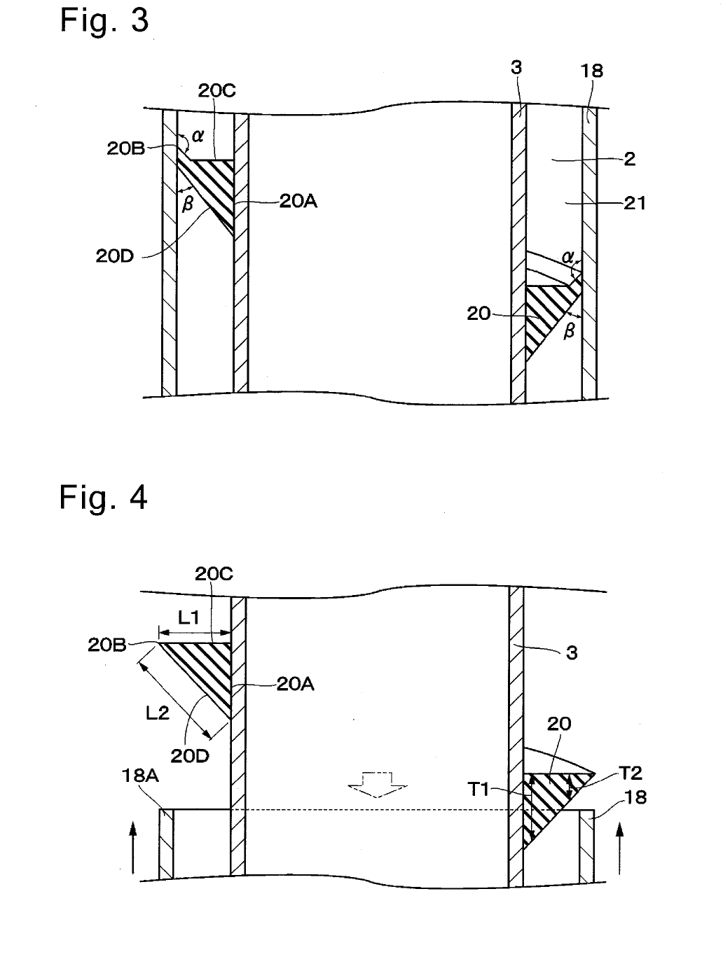

The partition walls 20 are attached to the outer peripheral side of the inner cylinder 3. The partition walls 20 are made of an insulating material. More specifically, the partition walls 20 are made of a high-polymer material, such as a synthetic rubber, with elasticity and electrical insulation properties as elastomers. The partition walls 20 are attached (bonded) to the inner cylinder 3, for example, with adhesive agent. As shown in FIGS. 3 and 4, each of the partition walls 20 has a sectional shape (longitudinal sectional shape) in which, for example, wall thickness T1 of an inner cylinder 3 side that is an attached side is smaller (thinner) than wall thickness T2 of an electrode tube 18 side that is a non-attached side across the whole radial length (horizontal direction in FIGS. 3 and 4). The sectional shape of each of the partition walls 20 is accordingly a right triangle in which the inner cylinder 3 side, or the attached side, is a base 20A, and pointed tip 20B side projects toward the electrode tube 18 at a sharp angle.

In this case, each of the partition walls 20 is attached to the inner cylinder 3 so that one of two ends of the base 20A, at which a right angle is formed, is located on an upstream side, or a high pressure side of the flow channels 21, that is, an axially upper side (oil hole 3A side), and that the other end of the base 20A, at which an acute angle is formed, is located on a downstream side, or a low pressure side of the flow channels 21, that is, an axially lower side (opposite side to the oil holes 3A). In other words, an angle formed by a high pressure-side surface 20C of each of the partition walls 20 and an outer peripheral surface of the inner cylinder 3 is a right angle. Each of the partition walls 20 is formed into an asymmetric triangle in which the pointed tip 20B is located further on the high pressure side as viewed in the axial direction of the inner cylinder 3.

To be more specific, as shown in FIG. 4, each of the partition walls 20 is so formed that length L1 between the inner cylinder 3 side of the each of the partition walls 20 and the pointed tip 20B, which is a radial length of the high pressure-side surface 20C, is shorter than length L2 between the inner cylinder 3 side and the pointed tip 20B, which is a radial length of a low pressure-side surface 20D of each of the partition walls 20. The pointed tip 20B of the non-attached side of each of the partition walls 20 is thus oriented to the high pressure side of the flow channels 21. In short, each of the partition walls 20 has a lip-like shape projecting toward the high pressure side.

As shown in FIG. 3, interference is provided in the fitting of the partition walls 20 and the electrode tube 18, or more precisely, each of the partition walls 20 has an external diameter larger than an internal diameter of the electrode tube 18. This makes a part of each of the partition walls 20, which is on the pointed tip 20B side, bulge (bend) toward the high pressure side (upward). For example, as shown in FIG. 3, when an angle formed by the electrode tube 18 to which the partition walls 20 are not attached and the high pressure-side surface 20C of each of the partition walls 20 is α, and an angle formed by the electrode tube 18 and the low pressure-side surface 20D of each of the partition walls 20 is β, the pointed tip 20B of the non-attached side of each of the partition walls 20 has the formed angle α larger than the formed angle β. In short, the formed angle α and the formed angle β have relation represented by an Expression 1 below.

α>β [Expression 1]

The following description will explain, with reference to FIG. 4, a method of assembling the inner cylinder 3 and the electrode tube 18, which is a method of producing the shock absorber 1.

First, the partition walls 20 are attached to the outer peripheral surface of the inner cylinder 3, for example, with adhesive agent (attachment step). The attachment (attachment step) of the partition walls 20 is not limited to adhesion using the adhesive agent, but may be performed using various attaching means. For example, the partition walls 20 may be baked onto the inner cylinder 3 by injection molding or other like means. The inner cylinder 3 to which the partition walls 20 are attached is then inserted into the electrode tube 18 (insertion step).

In the insertion step, the inner cylinder 3 is inserted from the low pressure side (lower side) of the inner cylinder 3 into an opening 18A formed in the high pressure side (upper side) of the electrode tube 18 as shown in FIG. 4. The insertion work only needs to relatively displace the electrode tube 18 and the inner cylinder 3 in such a direction that the electrode tube 18 and the inner cylinder 3 come close to each other. In other words, the insertion work may be carried out in such a way that only the inner cylinder 3 is displaced while the electrode tube 18 is fixed, that only the electrode tube 18 is displaced while the inner cylinder 3 is fixed or that both the electrode tube 18 and the inner cylinder 3 are displaced in such respective directions that the electrode tube 18 and the inner cylinder 3 come close to each other.

In any of the above cases, it is possible to reduce abutment angle (contact angle) between a rim of the high pressure-side opening 18A of the electrode tube 18 and the low pressure-side surface 20D of each of the partition walls 20, and therefore reduce insertion load. It is also possible to orient the pointed tip 20B of the non-attached side of each of the partition walls 20 toward the high pressure side of the flow channels 21. This enables both prevention of leakage from the flow channels 21 and improvement of assemblability at the same time.

The shock absorber 1 of the first embodiment is configured in the above-described manner. Operation of the shock absorber 1 will be now discussed.

To install the shock absorber 1 in a vehicle, such as an automobile, for example, the upper end side of the piston rod 9 is fixed to the body side of the vehicle, and the lower end side (bottom cap 5 side) of the outer cylinder 4 is fixed to a wheel side (axle side). When vertical vibration occurs while the vehicle is running due to unevenness of a road surface or the like, the piston rod 9 is displaced to expand or contract from the outer cylinder 4. At this time, the generated damping force of the shock absorber 1 is variably adjusted by generating a potential difference within the electrode path 19 in accordance with the command outputted from the controller, and by controlling the viscosity of the hydraulic fluid, or the electrorheological fluid, passing through the flow channels 21 in the electrode path 19.

For example, during the expansion stroke of the piston rod 9, the compression check valve 7 of the piston 6 is closed by the movement of the piston 6 in the inner cylinder 3. Before the disc valve 8 of the piston 6 is opened, the oil (hydraulic fluid 2) contained in the rod-side oil chamber B is pressurized to flow into the electrode path 19 through the oil holes 3A of the inner cylinder 3. An amount of the oil corresponding to the movement of the piston 6 flows from the reservoir chamber A, opens the expansion check valve 15 of the bottom valve 13, and enters the bottom-side oil chamber C.

During the compression stroke of the piston rod 9, the compression check valve 7 of the piston 6 is opened, and the expansion check valve 15 of the bottom valve 13 is closed, due to the movement of the piston 6 in the inner cylinder 3. Before the bottom valve 13 (disc valve 16) is opened, the oil contained in the bottom-side oil chamber C enters the rod-side oil chamber B. At the same time, an amount of the oil corresponding to an immersed volume of the piston rod 9 into the inner cylinder 3 flows from the rod-side oil chamber B through the oil holes 3A of the inner cylinder 3 to enter the electrode path 19.

In either case (either during the expansion or during the compression stroke), the oil which has entered the electrode path 19 passes through the electrode path 19 toward an outlet (lower side) and flows out of the electrode path 19 through the oil paths 17A of the retaining member 17 into the reservoir chamber A at a viscosity according to the potential difference of the electrode path 19 (potential difference between the electrode tube 18 and the inner cylinder 3). A damping force according to the viscosity of the hydraulic fluid 2 passing through the flow channels 21 in the electrode path 19 is generated, which enables the shock absorber 1 to absorb (damp) the vertical vibration of the vehicle.

For the reasons noted above, in the first embodiment, the sectional shape of each of the partition walls 20 is a triangle in which the wall thickness T2 on the pointed tip 20B side that is the non-attached side is smaller than the wall thickness T1 on the base 20A side that is the attached side. This makes it possible to reduce contact area of the pointed tip 20B side of each of the partition walls 20 and an inner peripheral surface of the electrode tube 18. According to an amount of decrease of the wall thickness of the pointed tip 20B side, the pointed tip 20B side can be more easily deformed than the base 20A side. Even if the interference between the pointed tip 20B side of each of the partition walls 20 and the inner peripheral surface of the electrode tube 18 is increased, it is possible to reduce the insertion load at the assembly of the inner cylinder 3 and the electrode tube 18.

In addition, the pointed tip 20B side of each of the partition walls 20 is oriented to the high pressure side of the flow channels 21. At the time of assembly of the inner cylinder 3 and the electrode tube 18, the inner cylinder 3 can be inserted in the electrode tube 18 by displacing a low pressure-side opening, not shown, of the inner cylinder 3 and the high pressure-side opening 18A of the electrode tube 18 in such respective directions that the low pressure-side opening and the high pressure-side opening 18A come close to each other. Such insertion makes it possible to reduce the abutment angle (contact angle) between the high pressure-side opening 18A of the electrode tube 18 and the low pressure-side surface 20D of each of the partition walls 20. From this viewpoint, the insertion load can be accordingly reduced.

Consequently, the assembling work of the inner cylinder 3 and the electrode tube 18 can be facilitated, for example, even if the interference is increased. This enables the prevention of leakage from the flow channels 21 and the improvement of assemblability at the same time. It is also possible to reduce a shearing force applied to the partition walls 20 during the assembling work. The partition walls 20 are thus less likely to fall off the inner cylinder 3. To put it the other way around, since the partition walls 20 are less likely to fall, attachment strength (adhesive strength) in the partition walls 20 and the inner cylinder 3 can be lowered.

Furthermore, since the pointed tip 20B side of each of the partition walls 20 is oriented to the high pressure side of the flow channels 21, the pointed tip 20B side of each of the partition walls 20 can be expanded toward the high pressure side. This makes it likely that a force (tensioning force) pressing the pointed tip 20B side onto the inner peripheral surface of the electrode tube 18 is applied to the pointed tip 20B side of each of the partition walls 20 due to the hydraulic fluid 2 flowing through the flow channels 21 on the high pressure side. This improves sealability (sealing performance, adhesion performance) between the pointed tip 20B side of each of the partition walls 20 and the inner peripheral surface of the electrode tube 18. Again, the hydraulic fluid 2 can be prevented from leaking from one of the flow channels 21 through a gap between the pointed tip 20B of the corresponding partition wall 20 and the inner peripheral surface of the electrode tube 18 into another one of the flow channels 21.

According to the first embodiment, as shown in FIG. 3, the pointed tip 20B side of each of the partition walls 20 has the formed angle α larger than the formed angle β, namely α>β. This makes it possible to reduce the abutment angle between the high pressure-side opening 18A of the electrode tube 18 and each of the partition walls 20 when the inner cylinder 3 and the electrode tube 18 are assembled. It is then likely that a force (tensioning force) pressing the pointed tip 20B side onto the inner peripheral surface of the electrode tube 18 is applied to the pointed tip 20B side of each of the partition walls 20 due to the hydraulic fluid 2 flowing through the flow channels 21 on the high pressure side.

According to the first embodiment, the partition walls 20 are attached to the outer peripheral surface side of the inner cylinder 3, which improves visibility of the partition walls 20, as compared to a configuration in which partition walls are attached to an inner peripheral surface side of an electrode tube. This facilitates the attachment of the partition walls 20 onto the inner cylinder 3, which is performed before the assembly of the inner cylinder 3 and the electrode tube 18, and also facilitates inspection and the like which is performed after the attachment.

According to the first embodiment, the partition walls 20 are made of an insulating material. This makes it possible to secure insulation properties of the electrode tube 18.

According to the first embodiment, the inner cylinder 3 is inserted from the low pressure side of the inner cylinder 3 into the high pressure-side opening 18A of the electrode tube 18. This makes it possible to reduce the abutment angle between the rim of the high pressure-side opening 18A of the electrode tube 18 and the low pressure-side surface 20D of each of the partition walls 20 and thus reduce the insertion load. The pointed tip 20B side of each of the partition walls 20 can be oriented to the high pressure side of the flow channels 21. This enables the prevention of leakage from the flow channels 21 and the improvement of assemblability at the same time.

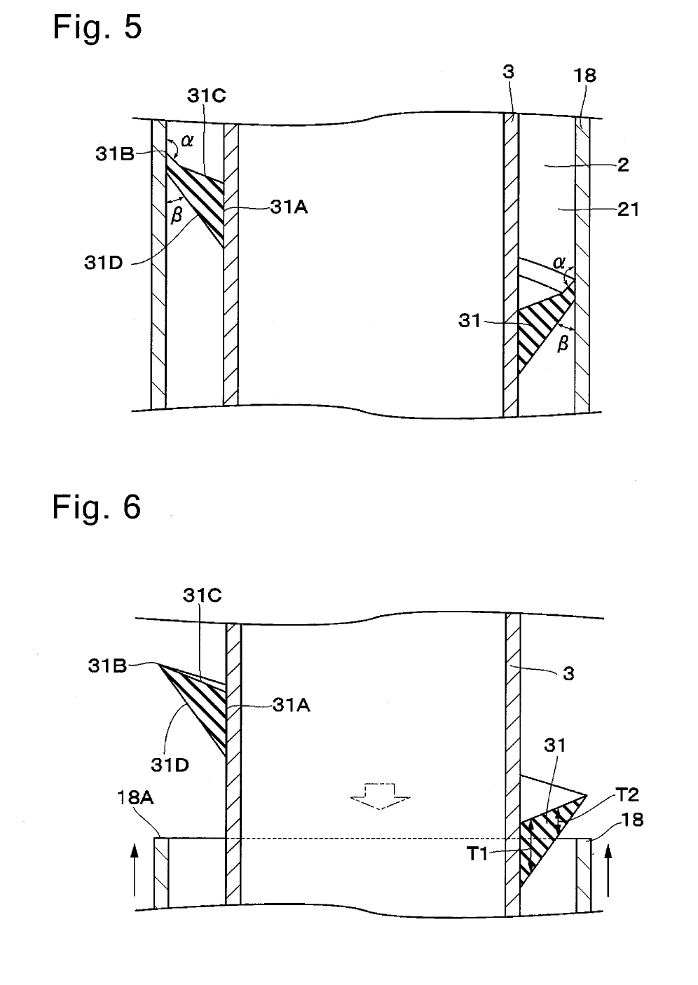

A second embodiment will be now discussed with reference to FIGS. 5 and 6. The second embodiment is characterized in that a high pressure-side surface of a partition wall is inclined toward a high pressure side. Constituent elements of the second embodiment which are equivalent to those of the first embodiment will be provided with the same reference signs, and the explanation thereof will be omitted.

Instead of the partition wall 20 of the first embodiment, the second embodiment utilizes a partition wall 31 functioning as flow-channel forming means. The partition wall 31 comprises a plurality of partition walls 31 disposed between an inner cylinder 3 and an electrode tube 18. The partition walls 31 thus form a plurality of flow channels 21 between the inner cylinder 3 and the electrode tube 18, that is, within an electrode path 19. The partition walls 31, as well as the partition walls 20 of the first embodiment, are each formed into a spiral shape including a portion extending in a circumferential direction. The flow channels 21 formed between the two respective adjacent partition walls 31 are also formed into spiral flow channels each including a portion extending in the circumferential direction.

The partition walls 31 are attached (bonded) to an outer peripheral surface of the inner cylinder 3, for example, with adhesive agent. As shown in FIGS. 5 and 6, each of the partition walls 31 has a sectional shape (longitudinal sectional shape) in which, for example, wall thickness T1 of an inner cylinder 3 side that is an attached side is smaller than wall thickness T2 of an electrode tube 18 side that is a non-attached side across the whole radial length (horizontal direction in FIGS. 5 and 6). More specifically, the sectional shape of each of the partition walls 31 is a (asymmetric) triangle in which the inner cylinder 3 side is a base 31A, and a pointed tip 31B side (vertex side) which is the non-attached side has an acute angle. In this case, each of the partition walls 31 is attached to the inner cylinder 3 so that one of two ends of the base 31A, at which an obtuse angle is formed, is located on an upstream side which is a high pressure side of the flow channels 21, that is, an axially upper side (oil hole 3A side), and that the other end of the base 31A, at which an acute angle is formed, is located on a downstream side which is a low pressure side of the flow channels 21, that is, an axially lower side (opposite side to the oil hole 3A side).

In this case, a high pressure-side surface 31C obliquely extends from the inner cylinder 3 side toward the high pressure side. The pointed tip 31B of the non-attached side of each of the partition walls 31 is oriented to the high pressure side of the flow channels 21. To be more specific, as shown in FIG. 5, an angle formed by the electrode tube 18 and the high pressure-side surface 31C of each of the partition walls 31 is α, and an angle formed by the electrode tube 18 and a low pressure-side surface 31D of each of the partition walls 31 is β. In this instance, the pointed tip 31B of the non-attached side of each of the partition walls 31 has the formed angle α larger than the formed angle β (α>β).

According to the second embodiment, the flow channels 21 are partitioned by the partition walls 31 described above. There is no particular difference in fundamental operation between the first and second embodiments. In particular, the second embodiment makes it easy to deform the pointed tip 31B side of each of the partition walls 31 in a radially inward direction (toward the inner cylinder 3) since the high pressure-side surface 31C of each of the partition walls 31 is inclined (undercut) toward the high pressure side. Again, the insertion load can be accordingly reduced.

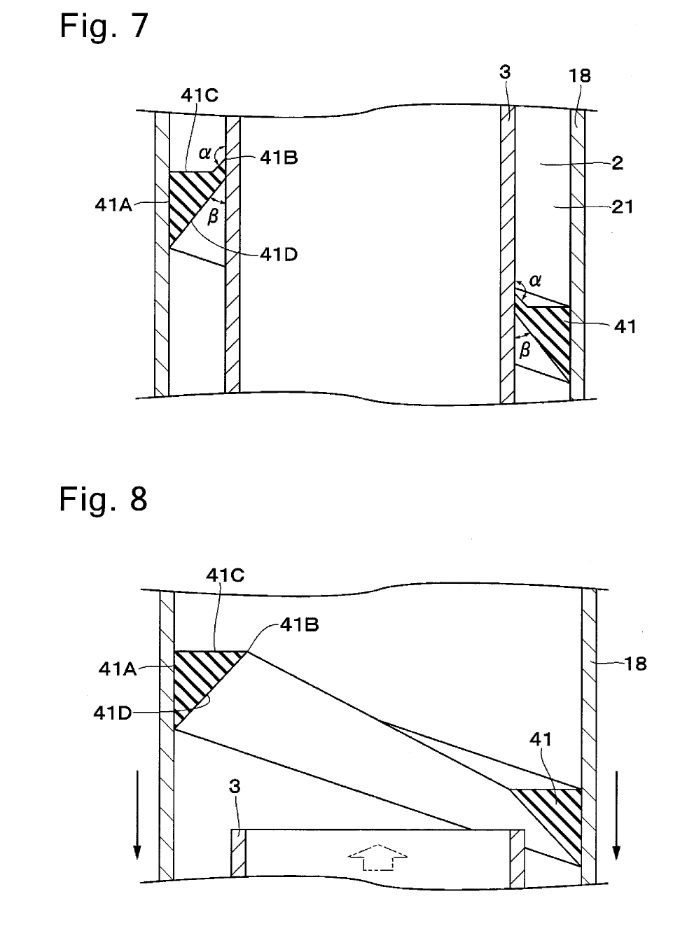

FIGS. 7 and 8 show a third embodiment. The third embodiment is characterized in that each partition wall is attached to an inner peripheral surface side of an intermediate cylinder (electrode tube). Constituent elements of the third embodiment which are equivalent to those of the first embodiment will be provided with the same reference signs, and the explanation thereof will be omitted.

Instead of the partition wall 20 of the first embodiment, the third embodiment utilizes a partition wall 41 as flow-channel forming means. The partition wall 41 comprises a plurality of partition walls 41 disposed between an inner cylinder 3 and an electrode tube 18. The partition walls 41 of the third embodiment are attached (bonded) to an inner peripheral surface of the electrode tube 18. As shown in FIGS. 7 and 8, the partition walls 41 each have a sectional shape in which an inner cylinder 3 side that is a non-attached side is smaller in wall thickness than an electrode tube 18 side that is an attached side.

Specifically, the sectional shape of each of the partition walls 41 is a (asymmetric) right triangle in which the electrode tube 18 side is a base 41A. In this case, each of the partition walls 41 is attached to the electrode tube 18 so that a right angle side is located on an upstream side which is a high pressure side of the flow channels 21, that is, an axially upper side (oil hole 3A side). In other words, an angle formed by a high pressure-side surface 41C of each of the partition walls 41 and the inner peripheral surface of the electrode tube 18 is a right angle.

Each of the partition walls 41 has a pointed tip 41B on the non-attached side. The pointed tip 41B is oriented to the high pressure side of the flow channels 21. To be more specific, as shown in FIG. 7, an angle formed by the inner cylinder 3 to which the partition walls 41 are not attached and the high pressure-side surface 41C of each of the partition walls 41 is α, and an angle formed by the inner cylinder 3 and a low pressure-side surface 41D of each of the partition walls 41 is β. In this instance, the pointed tip 41B of the non-attached side of each of the partition walls 41 has the formed angle α larger than the formed angle β (α>β).

A method of assembling the inner cylinder 3 and the electrode tube 18, which is a method of producing the shock absorber 1, will be now described with reference to FIG. 8.

First, the partition walls 41 are attached to the inner peripheral surface of the electrode tube 18, for example, with adhesive agent (attachment step). The inner cylinder 3 is then inserted into the electrode tube 18 to which the partition walls 41 are attached (insertion step). In the insertion step, as shown in FIG. 8, the inner cylinder 3 is inserted from a high pressure side (upper side) of the inner cylinder 3 into an opening, not shown, formed in a low pressure side (lower side) of the electrode tube 18. The insertion work only needs relative displacement of the electrode tube 18 and the inner cylinder 3 in such a direction that the electrode tube 18 and the inner cylinder 3 come close to each other. In other words, the insertion work may be carried out in such a way that only the inner cylinder 3 is displaced while the electrode tube 18 is fixed, that only the electrode tube 18 is displaced while the inner cylinder 3 is fixed or that both the electrode tube 18 and the inner cylinder 3 are displaced in such directions that the electrode tube 18 and the inner cylinder 3 come close to each other.

According to the third embodiment, the flow channels 21 are partitioned by the partition walls 41 described above. There is no particular difference in fundamental operation between the first and third embodiments. The third embodiment prevents the hydraulic fluid 2 from leaking from one of the flow channels 21 through a gap between the pointed tip 41B of the corresponding partition wall 41 and the outer peripheral surface of the inner cylinder 3 into another one of the flow channels 21. The third embodiment furthermore facilitates the assembling work of the inner cylinder 3 and the electrode tube 18.

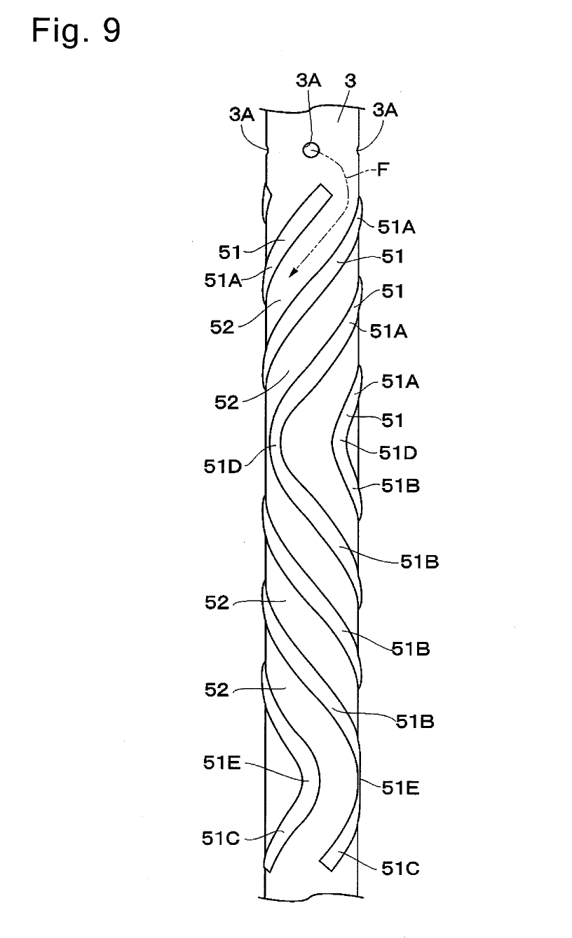

FIGS. 9 to 12 show a fourth embodiment. The fourth embodiment is characterized in that a flow channel through which a functional fluid flows is a meandering flow channel. Constituent elements of the fourth embodiment which are equivalent to those of the first embodiment will be provided with the same reference signs, and the explanation thereof will be omitted.

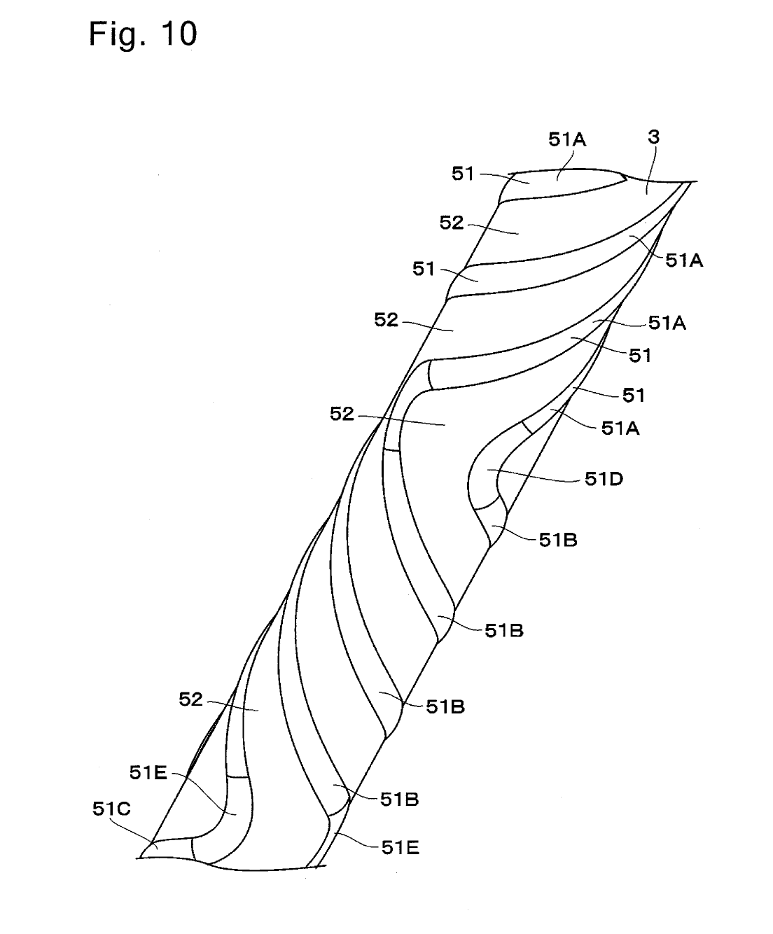

Instead of the partition wall 20 of the first embodiment, the fourth embodiment utilizes partition walls 51 as flow-channel forming means. The partition wall 51 comprises a plurality of partition walls 51 disposed between an inner cylinder 3 and an electrode tube 18. The partition walls 51 are attached (bonded) to an outer peripheral surface of the inner cylinder 3. In this embodiment, as shown in FIGS. 9 and 10, each of the partition walls 51 extends between the inner cylinder 3 and the electrode tube 18, obliquely meandering around a circumference, to thereby form meandering flow channels 52 between the electrode tube 18 and the inner cylinder 3. While the partition walls 20 of the first embodiment extend around the circumference from the upper end side to the lower end side of the inner cylinder 3 in the same direction, the partition walls 51 of the fourth embodiment turn at a certain point.

More specifically, each of the partition walls 51 extends obliquely in a first direction (for example, clockwise or anticlockwise) in one portion and extends obliquely in a second circumferential direction (for example, anticlockwise or clockwise) which is opposite to the first circumferential direction in another portion, as can be seen in a wavy line like a sine or cosine curve (for example, a curved or straight line which, before extending clockwise all the way around the inner cylinder 3, turns anticlockwise that is an opposite direction to the clockwise direction or a curved or straight line which, before extending anticlockwise all the way around the inner cylinder 3, turns clockwise that is an opposite direction to the anticlockwise direction).

Each of the partition walls 51 has a first clockwise portion 51A extending obliquely in the first circumferential direction (clockwise) as viewed from an axially upper side (oil hole 3A side) toward an axially lower side of the inner cylinder 3, an anticlockwise portion 51B extending obliquely in the second circumferential direction (anticlockwise) which is an opposite direction to the first circumferential direction, and a second clockwise portion 51C extending obliquely in the first circumferential direction (clockwise). The first clockwise portion 51A and the anticlockwise portion 51B are connected together at a first turning portion 51D. The anticlockwise portion 51B and the second clockwise portion 51C are connected together at a second turning portion 51E.

Each of the flow channels 52 which is formed between the two respective adjacent partition walls 51 is accordingly a meandering flow channel including a portion extending in the circumferential direction. According to the fourth embodiment thus configured, a fluid force flowing in the first circumferential direction and a fluid force flowing in the second circumferential direction act in such directions as to cancel each other out, so that it is possible to reduce a (total) turning force (torque, moment) applied from the hydraulic fluid 2 to the inner cylinder 3 and the electrode tube 18.

The partition walls 51 each have a triangular sectional shape as in the first to third embodiments. Each of the partition walls 51 has a sectional shape in which an electrode tube 18 side that is a non-attached side is smaller in wall thickness than an inner cylinder 3 side that is an attached side. In the fourth embodiment, as in the first to third embodiments, a pointed tip of the non-attached side of each of the partition walls 51 is oriented to a high pressure side of the flow channels 52.

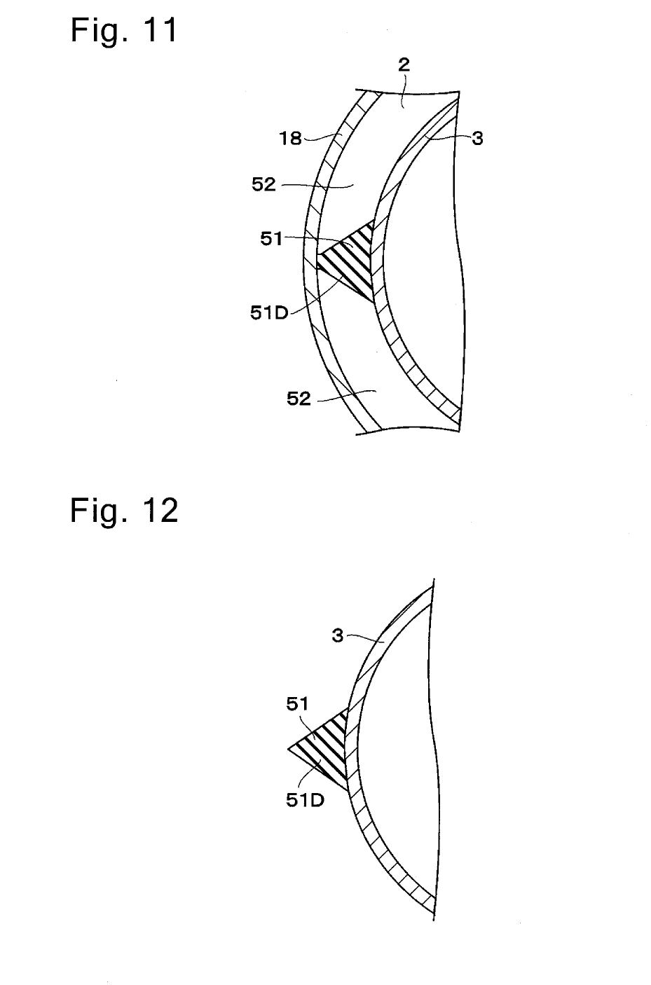

FIGS. 11 and 12 show a cross-section of the first turning portion 51D of each of the partition walls 51, that is, a cross-section along a direction orthogonal to an axial direction of the inner cylinder 3. As shown in FIGS. 11 and 12, the cross-section of each of the partition walls 51 is a triangle in which the inner cylinder 3 side is a base, and the pointed tip side (vertex side) that is the non-attached side has an acute angle. In this case, the turning portion 51D (51E) of each of the partition walls 51 is a region where a high pressure-side surface and a low pressure-side surface are inverted from each other. A vertex of the turning portion 51D (51E) of each of the partition walls 51 accordingly has an asymmetric sectional shape.

According to the fourth embodiment, the flow channels 52 are partitioned by the partition walls 51 described above. There is no particular difference in fundamental operation between the first and fourth embodiments. The fourth embodiment, as with the first embodiment, prevents the hydraulic fluid 2 from leaking from one of the flow channels 52 through a gap between the pointed tip of the corresponding partition wall 51 and the inner peripheral surface of the electrode tube 18 into another one of the flow channels 52. The fourth embodiment furthermore facilitates the assembling work of the inner cylinder 3 and the electrode tube 18.

The fourth embodiment has been discussed with the example of the configuration in which the partition walls 51 regulating the direction of the flow channels 52 are provided (attached) to (the outer peripheral side of) the inner cylinder 3. The invention, however, does not necessarily have to be configured that way. For example, the partition walls may be provided (attached) to (the inner peripheral side of) the electrode tube as in the third embodiment.

The first embodiment has been discussed with the example of the configuration in which the four partition walls 20 are provided as flow-channel faulting means (flow-channel forming members) for regulating the direction of the flow channels 21. The invention, however, does not necessarily have to be configured that way. For example, the invention may be provided with two, three, five or more partition walls. In that case, the number of the partition walls may be determined as needed according to necessary performance (damping performance), production cost, specifications, and the like. The same applies to the second to fourth embodiments.

The first embodiment has been discussed with the example of the configuration in which the plurality of flow channels 21 are formed by the plurality of partition walls 20. The invention does not necessarily have to be configured that way. For example, the invention may be so configured that one flow channel is formed by one partition wall (flow-channel forming member). The same applies to the second to fourth embodiments.

The first embodiment has been discussed with the example in which the partition walls 20 each have the triangular sectional shape. The sectional shape does not necessarily have to be triangle. Each of the partition walls 20 may have any sectional shape in which the non-attached side is smaller in wall thickness than the attached side. The sectional shape therefore may be, for example, a square (trapezoid) in which the non-attached side is a short side. The same applies to the second to fourth embodiments.

The first embodiment has been discussed with the example in which the partition walls 20 are made of a synthetic rubber. The partition walls 20 do not necessarily have to be made of a synthetic rubber and may be made of, for example, a high-polymer material, such as a synthetic resin, other than synthetic rubbers. Not only high-polymer materials, but also various other materials, which can be used to make the flow channels, are usable. In any case, the flow-channel forming means functioning as the partition walls is made of an insulating material having electrical insulation properties. The same applies to the second to fourth embodiments.

The embodiments have been discussed with the example of the configuration in which the shock absorber 1 is vertically installed. The invention does not necessarily have to be configured that way. The shock absorber 1 may be installed in a desired orientation depending on an object on which the shock absorber 1 is mounted. For example, the shock absorber 1 may be installed at a tilt without causing aeration.

The embodiments have been discussed with the example of the configuration in which the hydraulic fluid 2 flows from the axially upper end side toward the axially lower end side. The invention, however, does not necessarily have to be configured that way. The invention may be so configured that the hydraulic fluid 2 flows from one axial end side toward the other axial end side according to the installed orientation of the shock absorber 1. For example, the hydraulic fluid 2 may flow from the lower end side toward the upper end side, from a left (or right) end side toward a right (or left) end side or from a front (or rear) end side toward a rear (or front) end side.

The embodiments have been discussed with the example in which the hydraulic fluid 2 as the functional fluid is made of the electrorheological fluid (ER fluid). The hydraulic fluid 2, however, does not necessarily have to be made of the electrorheological fluid. For example, the hydraulic fluid as the functional fluid may be made of a magnetorheological fluid (MR fluid) that changes in fluid properties due to a magnetic field. If the magnetorheological fluid is used, the electrode tube 18 that is the intermediate cylinder may be used as a magnetic pole, instead of the electrode (magnetic field from a magnetic field supply portion is imparted to a magnetic pole tube that is an intermediate cylinder). In this instance, for example, a magnetic field is generated (in a magnetic pole path) between the inner cylinder and the magnetic pole tube by the magnetic field supply section, and the magnetic field is variably controlled to adjust the generated damping force in a variable manner. The retaining members 11 and 17 for insulation and other like elements may be made of, for example, a non-magnetic material.

The embodiments have been discussed with the example in which the shock absorber 1 as the cylinder device is used in a four-wheeled vehicle. The shock absorber 1, however, does not necessarily have to be used in a four-wheeled vehicle. For example, the shock absorber 1 is widely usable as various kinds of absorbers (cylinder devices) for absorbing a shock in an object that needs shock absorption. Such absorbers include shock absorbers used in two-wheeled vehicles, shock absorbers used in rail vehicles, shock absorbers used in various machinery devices including general industrial devices, shock absorbers used in architectural structures, and other like shock absorbers. Needless to say, the embodiments are examples, and the configurations discussed in different embodiments may be partially replaced or combined with each other. The cylinder device (shock absorber) may be altered in design without deviating the gist of the invention.

The embodiments enable the prevention of leakage from the flow channels and the improvement of assemblability at the same time.

More specifically, according to the embodiments, the flow-channel forming means has a sectional shape in which the non-attached side is smaller in wall thickness than the attached side. This reduces contact area between the non-attached side of the flow-channel forming means and a counterpart surface (the inner peripheral surface of the intermediate cylinder or the outer peripheral surface of the inner cylinder). According to an amount of decrease of the wall thickness of the non-attached side, the non-attached side of the flow-channel forming means can be more easily deformed, as compared to the attached side. Even if the interference between the non-attached side of the flow-channel forming means and the counterpart surface (the inner peripheral surface of the intermediate cylinder or the outer peripheral surface of the inner cylinder) is increased, it is possible to reduce the insertion load at the assembly of the inner cylinder and the intermediate cylinder.

The pointed tip of the non-attached side of the flow-channel forming means is oriented to the high pressure side of the flow channels. At the assembly of the inner cylinder and the intermediate cylinder, the inner cylinder can be inserted into the intermediate cylinder by displacing the low pressure-side opening (rim) of the cylinder to which the flow-channel forming means is attached and the high pressure-side opening (rim) of the cylinder to which the flow-channel forming means is not attached in such directions that the low pressure-side opening and the high pressure-side opening come close to each other. The insertion described above makes it possible to reduce the abutment angle (contact angle) between the high pressure-side opening (rim) of the cylinder to which the flow-channel forming means is not attached and the flow-channel forming means. From this viewpoint, the insertion load can be accordingly reduced.

Consequently, for example, even if the interference is increased, the assembling work of the inner cylinder and the intermediate cylinder can be facilitated, which enables both the prevention of leakage from the flow channels and the improvement of assemblability at the same time. The shearing force applied to the flow-channel forming means during the assembling work also can be reduced. This discourages the flow-channel forming means from falling off the inner cylinder or the intermediate cylinder. To put it the other way around, since the flow-channel forming means is less likely to fall, it is possible to accordingly reduce attachment strength (adhesive strength) of the inner or intermediate cylinder and the flow-channel forming means.

Since the pointed tip of the non-attached side of the flow-channel forming means is oriented to the high pressure-side of the flow channels, a part of the pointed tip of the non-attached side can be expanded to the high pressure side. It is then likely that the force (tensioning force) pressing the pointed tip onto the counterpart surface (the inner peripheral surface of the intermediate cylinder or the outer peripheral surface of the inner cylinder) is applied to the pointed tip of the non-attached side due to the functional fluid flowing through the flow channels on the high pressure side. This improves sealability (sealing performance, adhesion performance) between the flow-channel forming means and the counterpart surface (the inner peripheral surface of the intermediate cylinder or the outer peripheral surface of the inner cylinder). Again, the functional fluid can be prevented from leaking from the flow channels through the gap between the pointed tip side of the flow-channel forming means and the counterpart surface (the inner peripheral surface of the intermediate cylinder or the outer peripheral surface of the inner cylinder).

According to the embodiments, when the angle formed by the inner or intermediate cylinder to which the flow-channel forming means is not attached and the high pressure-side surface is α, and the angle formed by the inner or intermediate cylinder to which the flow-channel forming means is not attached and the low pressure-side surface is β, the pointed tip of the non-attached side of the flow-channel forming means has the angle α larger than the angle β, namely α>β. This makes it possible to reduce the abutment angle (contact angle) between the high pressure-side opening (rim) of the cylinder to which the flow-channel forming means is not attached and the flow-channel forming means at the assembly of the inner cylinder and the intermediate cylinder. It is possible to make it likely that the force (tensioning force) pressing the pointed tip onto the counterpart surface (the inner peripheral surface of the intermediate cylinder or the outer peripheral surface of the inner cylinder) is applied to the pointed tip of the non-attached side due to the functional fluid flowing through the flow channels on the high pressure side.

According to the embodiments, the flow-channel forming means is attached to the inner cylinder. Since the flow-channel forming means is attached to the outer peripheral surface side of the inner cylinder, the visibility of the flow-channel forming means is improved, as compared to the configuration in which the flow-channel forming means is attached to the inner peripheral surface side of the intermediate cylinder. This facilitates the attachment of the flow-channel forming means and the inner cylinder, which is performed before the assembling work of the inner cylinder and the intermediate cylinder, and also facilitates the inspection and the like, which is performed after the attachment.

According to the embodiments, the flow-channel forming means is made of an insulating material. This makes it possible to secure the insulation properties of the intermediate cylinder functioning as the electrode tube.

According to the embodiments, if the flow-channel forming means is attached to the outer peripheral side of the inner cylinder, the inner cylinder is inserted from the low pressure side of the inner cylinder into the high pressure-side opening of the intermediate cylinder. If the flow-channel forming means is attached to the inner peripheral side of the intermediate cylinder, the inner cylinder is inserted from the high pressure side of the inner cylinder into the low pressure-side opening of the intermediate cylinder. This reduces the abutment angle (contact angle) between the high pressure-side opening (rim) of the cylinder to which the flow-channel forming means is not attached and the flow-channel forming means, and thus also reduces the insertion load. In addition, the pointed tip of the non-attached side of the flow-channel forming means can be oriented to the high pressure side of the flow channels. It is therefore possible to enable both the prevention of leakage from the flow channels and the improvement of assemblability at the same time.

Conceivable aspects of the cylinder device according to the foregoing embodiments include, for example, the ones described below.

A first aspect is a cylinder device comprising an inner cylinder configured to sealingly contain a functional fluid that changes in fluid properties due to an electric or magnetic field, the inner cylinder through which a rod extends; an intermediate cylinder disposed at an outer side of the inner cylinder and configured as an electrode tube or a magnetic pole tube; and flow-channel forming means disposed between the inner cylinder and the intermediate cylinder and forming one or more flow channels through which the functional fluid flows from one axial end side toward the other axial end side in response to a back-and-forth movement of the rod, wherein the flow channel is a spiral or meandering flow channel including a portion extending in a circumferential direction; the flow-channel forming means is attached to either the inner cylinder or the intermediate cylinder; the flow-channel forming means has a sectional shape in which a non-attached side is smaller in wall thickness than an attached side, and a pointed tip of the non-attached side is oriented to a high pressure side of the flow channel.

A second aspect according to the first aspect is characterized in that, when an angle formed by the inner or intermediate cylinder to which the flow-channel forming means is not attached and a high pressure-side surface is α, and an angle formed by the inner or intermediate cylinder to which the flow-channel forming means is not attached and a low pressure-side surface is β, the relation between the angle α and the angle β is α>β.

A third aspect according to the first or second aspect is characterized in that the flow-channel forming means is attached to the inner cylinder.

A fourth aspect according to any one of the first to third aspects is characterized in that the flow-channel forming means is made of an insulating material.

A fifth aspect is a method of producing a cylinder device comprising an inner cylinder configured to sealingly contain a functional fluid that changes in fluid properties due to an electric or magnetic field, the inner cylinder through which a rod extends; an intermediate cylinder disposed at an outer side of the inner cylinder and configured as an electrode tube or a magnetic pole tube; and flow-channel forming means disposed between the inner cylinder and the intermediate cylinder and forming one or more flow channels through which the functional fluid flows from one axial end side toward the other axial end side in response to a back-and-forth movement of the rod, wherein the flow channel is a spiral or meandering flow channel including a portion extending in a circumferential direction; and the flow-channel forming means is attached to an outer peripheral side of the inner cylinder, the flow-channel forming means has a sectional shape in which a non-attached side is smaller in wall thickness than an attached side, the method including an insertion step of inserting the inner cylinder from a low pressure side of the inner cylinder into a high pressure-side opening of the intermediate cylinder.

A sixth aspect is a method of producing a cylinder device comprising an inner cylinder configured to sealingly contain a functional fluid that changes in fluid properties due to an electric or magnetic field, the inner cylinder through which a rod extends; an intermediate cylinder disposed in an outer side of the inner cylinder and configured as an electrode tube or a magnetic pole tube; and flow-channel forming means disposed between the inner cylinder and the intermediate cylinder and forming one or more flow channels through which the functional fluid flows from one axial end side toward the other axial end side in response to a back-and-forth movement of the rod, wherein the flow channel is a spiral or meandering flow channel including a portion extending in a circumferential direction; and the flow-channel forming means is attached to an inner peripheral side of the intermediate cylinder, the flow-channel forming means has a sectional shape in which a non-attached side is smaller in wall thickness than an attached side, the method including an insertion step of inserting the inner cylinder from a high pressure side of the inner cylinder into a low pressure-side opening of the intermediate cylinder.

The foregoing description refers to only a few embodiments of the invention. One skilled in the art should easily understand that the exemplary embodiments may be modified or improved in various ways without materially deviating from the novel teachings and advantages of the invention. Accordingly, all such modifications and improvement are intended to be included within the technical scope of the invention. The embodiments may be combined in any ways.

The present application claims priority under Japanese Patent Application No. 2016-033331 filed on Feb. 24, 2016. The entire disclosure of Japanese Patent Application No. 2016-033331 filed on Feb. 24, 2016, including the description, claims, drawings and abstract, is incorporated herein by reference in its entirety.

The entire disclosure of Japanese Patent Application No. 2014-135183 including the description, claims, drawings and abstract, is incorporated herein by reference in its entirety.

### REFERENCE SIGNS LIST

1: Shock absorber (cylinder device)
2: Hydraulic fluid (functional fluid, electrorheological fluid)
3: Inner cylinder
4: Outer cylinder
9: Piston rod (rod)
18: Electrode tube (intermediate cylinder)
19: Electrode path (intermediate path)
20, 31, 41, 51: Partition wall (flow-channel forming means)
21, 52: Flow channel

1. A cylinder device comprising:
an inner cylinder configured to sealingly contain a functional fluid that changes in fluid properties due to an electric or magnetic field, the inner cylinder through which a rod extends;
an intermediate cylinder disposed at an outer side of the inner cylinder, the intermediate cylinder being configured as an electrode tube or a magnetic pole tube; and
flow-channel forming means that is disposed between the inner cylinder and the intermediate cylinder and that forms one or more flow channels through which the functional fluid flows from one axial end side toward the other axial end side in response to a back-and-forth movement of the rod, wherein
the flow channel is a spiral or meandering flow channel including a portion extending in a circumferential direction;
the flow-channel forming means is attached to either the inner cylinder or the intermediate cylinder;
the flow-channel forming means has a sectional shape in which a non-attached side is thinner in wall thickness than an attached side, and
a pointed tip of the non-attached side is oriented to a high pressure side of the flow channel.

2. The cylinder device described in claim 1, wherein
when an angle formed by the inner or intermediate cylinder to which the flow-channel forming means is not attached and a high pressure-side surface is α, and an angle formed by the inner or intermediate cylinder to which the flow-channel forming means is not attached and a low pressure-side surface is β, the relation between the angle α and the angle β is α>β.

3. The cylinder device described in claim 1, wherein the flow-channel forming means is attached to the inner cylinder.

4. The cylinder device described in claim 1, wherein the flow-channel forming means is made of an insulating material.

5. A method of producing a cylinder device comprising:
an inner cylinder configured to sealingly contain a functional fluid that changes in fluid properties due to an electric or magnetic field, the inner cylinder through which a rod extends;
an intermediate cylinder disposed at an outer side of the inner cylinder, the intermediate cylinder being configured as an electrode tube or a magnetic pole tube; and
flow-channel forming means that is disposed between the inner cylinder and the intermediate cylinder and that forms one or more flow channels through which the functional fluid flows from one axial end side toward the other axial end side in response to a back-and-forth movement of the rod, wherein
the flow channel is a spiral or meandering flow channel including a portion extending in a circumferential direction; and
the flow-channel forming means is attached to an outer peripheral side of the inner cylinder,
the flow-channel forming means has a sectional shape in which a non-attached side is thinner in wall thickness than an attached side, the method including an insertion step of inserting the inner cylinder from a low pressure side of the inner cylinder into a high pressure-side opening of the intermediate cylinder.

6. A method of producing a cylinder device comprising:
an inner cylinder configured to sealingly contain a functional fluid that changes in fluid properties due to an electric or magnetic field, the inner cylinder through which a rod extends;
an intermediate cylinder disposed at an outer side of the inner cylinder, the intermediate cylinder being configured as an electrode tube or a magnetic pole tube; and
flow-channel forming means that is disposed between the inner cylinder and the intermediate cylinder, and that forms one or more flow channels through which the functional fluid flows from one axial end side toward the other axial end side in response to a back-and-forth movement of the rod, wherein
the flow channel is a spiral or meandering flow channel including a portion extending in a circumferential direction; and
the flow-channel forming means is attached to an inner peripheral side of the intermediate cylinder,
the flow-channel forming means has a sectional shape in which a non-attached side is thinner in wall thickness than an attached side, and
the method includes an insertion step of inserting the inner cylinder from a high pressure side of the inner cylinder into a low pressure-side opening of the intermediate cylinder.

7. The cylinder device described in claim 2, wherein the flow-channel forming means is attached to the inner cylinder.

8. The cylinder device described in claim 2, wherein the flow-channel forming means is made of an insulating material.

9. The cylinder device described in claim 3, wherein the flow-channel forming means is made of an insulating material.
